(19) United States
(12) Patent Application Publication
(10) Pub. No.: US 2003/0051007 A1
(43) Pub. Date: Mar. 13, 2003

(54) Apparatus and method for optimizing telecommunication network design using weighted span classification for low degree of separation demands

(76) Inventors: Sheri L. Zimmel, Richardson, TX (US); Kristopher E. Glover, Richardson, TX (US); Anna A. Maravina, Richardson, TX (US); Mark W. Lewis, Oxford, MS (US)

Correspondence Address: Rudolf O. Siegesmund, 4627 N. Central Expressway, Ste. 2000, Dallas, TX, 75205, US

(21) Appl. No.: 09/905,748

(22) Filed: Jul. 14, 2001

(51) Int. Cl. G06F 15/173; G06F 15/177

(52) U.S. Cl. 709/220; 709/238

(57) ABSTRACT

Based upon given demands, nodes, spans, speed hierarchy, equipment, weights, preferences and constraints, the apparatus and method disclosed creates an optimized network configuration by separating low degree of separation demands and employing functional analysis for equipment selection and functional analysis for demand routing. The method includes picking a cycle to place equipment on and routing demands on the cycle.

### TECHNICAL FIELD OF THE INVENTION

This invention pertains to the arts of network planning, design and optimization, and especially to those arts related to determination of an optimized telecommunications network configuration through consideration of constraints that are represented by numerical weights being applied to single structures.

### BACKGROUND OF THE INVENTION

In recent years, two major technological and social forces have interacted to accelerate the planning, design, and deployment of communications networks. The public switched telephone network (“PSTN”) has converted from analog technology to digital technology, and Internet and intranet traffic has grown exponentially. The conversion to digital technology and the growth in Internet and intranet traffic have enabled and driven convergence of voice and data traffic in communications networks. The convergence has caused changes in the types of equipment specified, purchased and operated by communications network operators, such as local or regional telephone services providers or “regional Bell operating companies” (“RBOCs”), long distance carriers, and data communications services companies. The convergence has also caused communications network operators to offer new services beyond the traditional offerings such as “plain old telephone” service (“POTS”), long distance service, and data communications. New services offered from a single service provider now minimally includes long distance, virtual private networks, Internet traffic management and website hosting, along with traditional services. As a result of these increased service demands, communications network operators are driven to maximize the utilization of existing network topologies, to create new networks, and to expand existing networks.

When new networks are needed to meet new demands, telecommunication companies turn to design engineers to create a cost effective network by developing topologies for the demands. Due to increasing network complexities the engineers need software to generate multiple network configuration scenarios to determine customized network configuration solutions to meet particular needs rather than generic network design.

Network configuration optimization problems are not unique to the communications industry. City street traffic planning, railroad cargo and railcar routing, and airline routing share the same fundamental concepts, problems and needs. As such, those skilled in the arts of any of these technologies, or in the more generic technologies of graph and network theory, will recognize that the methods and tools provided to assist engineers practicing one art will be readily useable or adaptable to other related arts. For example, in graph theory terminology, a “vertex” would correspond to a “node” in a telecommunications network, and an “edge” would correspond to a “span” or “link”. Likewise, a “cycle” in graph theory terminology would correspond to a “ring” in a telecommunications network. As such, algorithms commonly employed in graph theory are often useful in telecommunications network planning and design.

Optimization of network resources requires proper use of a network topology. Communications networks have several fundamental topologies. The simplest of the topologies is the “point to point” network. FIG. 1 depicts “point to point” network 10 with “node A” 11 connected to “node B” 12 by “span A-B” 15, “node B” 12 connected to “node C” 13 by “span B-C” 16, “node C” 13 connected to “node D” 14 by “span C-D” 17. “Node A” 11, “node B” 12, “node C” 13 and “node D” 14 may consist of telephony switches, such as central-office class switches (e.g. SS7 switches) and data routers. “Span AB” 15, “span BC” 16, and “span CD” 17 may be wired telecommunications transmission media, such as T1, DS3, optical transmission means, or wireless technologies such as microwave or satellite transceivers. Communication “spans” or “links” are formed between two nodes, such as “node A” 11 and “node D” 14. Intermediate nodes, such as “node B” 12 and “node C” 13, may also be traversed as traffic travels between “node A” 11 and “node D” 14.

Characteristically, topologies, which use single links between each node in the path between end points, do not offer alternate paths to a destination at any particular node. These types of topologies may be the least expensive networks to implement, primarily because of the lack of redundant hardware and span cabling or fiber. However, these types of topologies are also generally prone to catastrophic failure because the failure of one node or one span in the network may result in a total loss of communications between the effected sections of the network.

A “star” topology is also a network arrangement, found most often in the arrangement between extension telephones and a private branch exchange switch (“PBX”), or between client computers and a local area network (“LAN”) hub. Star topologies are found less often in a telecommunications transport arrangements. FIG. 2 shows star 20 wherein “node K” 21 is a hub providing centralized switching or routing to outlying “node E” 22, “node F” 23, “node G” 24, “node H” 25 and “node J” 26. A star topology is cost-efficient in terms of the costs of switching or routing hardware and span media. The star topology can survive the loss of one of the outlying nodes. However, failure of “node K” 21 results in total loss of communications in the network, and thus the star network is not suitable for high-reliability applications.

A “ring” topology is a topology in which a path can be found from a starting point or node though the network back to the starting point or node. It is often used in local area networks as well as wide area networks. FIG. 3 depicts ring 40 as an example of a “ring” network. The most fundamental form of a ring network is a unidirectional ring, in which traffic traverses the ring in a clockwise or counterclockwise direction. Failure of any single span or node in the unidirectional ring can isolate a portion of the ring for communications. A more common type of ring is a counter-rotational ring, in which traffic traverses the ring in both directions, clockwise and counter-clockwise. A counter-rotational ring can be “self-healing” by looping back traffic when a node or span fails. For example, if “node P” 44 fails, the traffic headed towards “node P” 44 from “node N” 43 and “node Q” 45 may be looped back onto the counter direction ring, thus forming a virtual ring of Q-L-M-N-M-L-Q. Thus, only traffic sourced from or destined to “node P” 44 is lost, and all other traffic may continue to flow to and from all other nodes. Therefore, counter-rotational ring topology has become the most prevalent topology in communication networks.

A “mesh” network is a network implemented using a topology in which at least two nodes are connected by more than one path. In a fully connected mesh network, a direct path connects all nodes of the network to each other.

A “hybrid” network is a combination of any two or more network topologies.

FIG. 4 shows network 60 as an example of a typical real network topology. Network 60 can be viewed in part as several ideal network topologies interconnected to each other (stars, rings and point-to-points). The interconnected network topologies typically include hundreds to thousands of nodes and spans interconnected in irregular patterns. Nodes may be co-located, such as on a corporate campus, or they may be physically disparate, such as in different cities.

The topologies are used for communication. Communication means the transfer of information among users or processes, according to Protocol Hierarchy Systems. Data means the representation of facts, concepts, or instructions in a formalized manner suitable for communication, interpretation, or processing by humans or by automatic means.

A communication system is any organized assembly of communications resources and procedures united and regulated by interaction or interdependence to accomplish a set of specific functions in the transfer of information. Telecommunication is any transmission, emission, or reception of signals, images, sounds or intelligence of any nature by wire, radio, optical, or other electromagnetic systems. A signal is any detectable transmitted energy that can be used to carry information in a communication system. A digital signal is a signal in which discrete steps or values are used to represent information.

A source is that part of a system from which messages are considered to originate. A destination is that part of a system to which messages are considered to be directed. A sink is a device that receives information, control, or other signals from a source. A demand in communications networks is the complete set of communications signals carried by a communications system or a set of communications systems. A transition point is a location within a communications network at which a demand unit moves from one system to another. A demand unit, in communications networks, is a unit of communication that consumes some level of bandwidth available in a communications network. A separation is the spatial distance between the source and destination of a traffic demand as determined by the number of systems traversed in delivering the demand from the source to the destination. The speed is the rate of communications between two points in a communications network. The term speed may refer either to the communications rate possible between two pieces of network equipment or to the bandwidth consumed by a demand unit placed upon communications system. A communications network element is a piece of communications equipment that allows a demand unit to either enter or exit a communications network, or transition to another system within the communications network.

Protocol Hierarchy Systems are constructions of interrelated levels of signals in a communications system. Protocol Hierarchy Systems include, but are not limited to T-Carrier (T-n), DS-n, E-Carrier, E-n, Optical Carrier (OC-n), SONET, Synchronous Transport Signal (STS-n), Synchronous Transport Module (STM-n), and Ethernet.

Digital Signal (DS) means a signal in which discrete steps or values are used to represent information, and also means a communications protocol used within an electrical-based signal multiplexing system commonly used by telecommunications carrier networks, known as T-carrier.

Digital Signal (DS-n) is the generic designator for any of several digitally multiplexed telecommunications carrier systems. A generalized protocol used in the transmission of digitized electrical signals from a source to a sink in a communications network. This protocol is adapted to handle specific communications rates agreed to by convention. By convention, communications networks utilizing the digital signal protocol may communicate information at one or more of the following rates: DS0, DS1, DS1C, DS2, DS3 and SDS3 (SYNTRAN). Other transfer rates may be extrapolated by a creator of a digital signal transmission system, that do not conform to conventional rates but are never the less considered elements of the digital signal hierarchy.

T-carrier is the generic designator for any one of several digitally multiplexed telecommunications carrier systems commonly used in North America and have a base signal rate of 64-kbps. T-carrier systems are composed of both a physical and a logical communications protocol.

E-carrier is the generic designator for any one of severally digitally multiplexed telecommunications carrier systems commonly used outside of North America and have a base signal rate of 64-kpbs. E-carrier systems are composed of both a physical and a logical communications protocol.

Optical Carrier is a physical digital signal transmission system that utilizes photons, rather than electrical impulses to transmit digitized information between sources and sinks in a communications network. The preferred transmission media for optical carrier systems is commonly acknowledged to be fiber optic media though “through-the-air” optical carrier transmission systems exist.

Synchronous Optical Network (SONET) is a communications system that has both electrical and optical transmission components. Physical communications are performed by using photons to communicate logically interleaved digitized signals from sources to sinks of a network over a media, commonly found to be fiber optic elements. The physical communications media is referred to as the optical carrier. This optical carrier may communicate at various signaling rates. By convention, SONET initially supported up to 256 levels of optical carrier communications rates though—by convention—only a handful of the levels were implemented (Specifically, OC-1, OC-3, OC-12, OC-48, OC-192, and OC-768), each level being an integral multiple of the Level 1 Optical Carrier rate (OC-1 communicates at a line rate of 51.940-Mbps). Because communications technology in various fields of research continues to improve, n is no longer seen to be limited at 256 and may be any value indicating an integer multiple of the base rate unit OC-1.

Synchronous Transport Signal (STS) is the electrically oriented logical protocol component of SONET communications systems. For every optical carrier level of a SONET system, a complementary synchronous transport signal exists at that level (the level of one Optical Carrier (OC-1) is complemented by an STS-1 signal, the level three Optical Carrier (OC-3) is complemented by an STS-3 signal, and so on).

Each protocol has a hierarchy. T-carrier systems are created to enable electrically based digital signals of 64-kbps to be multiplexed into signals of increasing communications rate. By convention, several T-carrier systems commonly exist though proprietary systems may be constructed having non-conventional multiplexing systems but operate as T-carrier systems. Table 1 delineates the conventional T-carrier systems available:

TABLE 1
T-Carrier System Hierarchy

| Signal | | Digital Signal | Signal | |
|---|---|---|---|---|
| Level | Base Rate | Level | Channels | Bit Rate |
| 0 | 64-kbps | DS-0 | 1 | 64-kbps |
| 1 | 64-kbps | DS-1 | 24 | 1.544-Mbps |
| 1C | 64-kbps | DS-1C | 48 | 3.152 Mbps |
| 2 | 64-kbps | DS-2 | 96 | 6.3123 Mbps |
| 3 | 64-kbps | DS-3 | 672 | 44.736 Mbps |

E-carrier systems are created to enable electrically based digital signals of 64-kbps to be multiplexed into signals of increasing communications rate. By convention, several E-carrier systems commonly exist though proprietary systems may be constructed having non-conventional multiplexing systems but operate as E-Carrier systems. Table 2 delineates the conventional E-carrier systems available:

TABLE 2
E-Carrier System Hierarchy

| Signal | | E-Carrier | Signal | |
|---|---|---|---|---|
| Level | Base Rate | Signal Level | Channels | Bit Rate |
| 0 | 64-kbps | E-0 | 1 | 64-kbps |
| 1 | 64-kbps | E-1 | 30 | 2.048 Mbps |
| 2 | 64-kbps | E-2 | 120 | 8.448 Mbps |
| 3 | 64-kbps | E-3 | 480 | 34.368 Mbps |
| 4 | 64-kbps | E-4 | 1920 | 139.268 Mbps |
| 5 | 64-kbps | E-5 | 7680 | 565.148 Mbps |

An Optical Carrier (OC-n) is a physical digital signal transmission system that utilizes photons rather than electrical impulses to transmit digitized information between sources and sinks in a communications network. The preferred transmission media for optical carrier systems is commonly acknowledged to be fiber optic media though “through-the-air” optical carrier transmission systems exist.

A signal level hierarchy exists for the transmission of information using optical carrier. Table 3 illustrates the most common signal levels available using optical carrier technology and the transfer rates available:

TABLE 3
Conventional Optical Carrier Signal Transfer Levels

| Signal Level | Optical Carrier | Data Rate |
|---|---|---|
| 1 | OC-1 | 51.840-Mbps |
| 3 | OC-3 | 155.520-Mbps |
| 12 | OC-12 | 622.080-Mbps |
| 48 | OC-48 | 2,488.320-Mbps |
| 192 | OC-192 | 9,953.280-Mbps |
| 768 | OC-768 | 39,813.12-Mbps |

Synchronous Digital Hierarchy (SDH) is a communications system that has both electrical and optical transmission components. Physical communications are performed by using photons, to communicate logically interleaved digitized signals from sources to sinks of a network over a media, commonly found to be fiber optic elements. The physical communications media is referred to as the optical carrier. This optical carrier may communicate at various signaling rates. By convention, SDH utilizes minimally, levels 3, 12, 48, and 192 of the Optical Carrier hierarchy (OC-3, OC-12, OC-48, and OC-192) to signal Synchronous Transport Module signals of level 1, 4, 16, and 64 (STM-1, STM-4, STM-16, STM-64). Table 4 illustrates common Synchronous Transport Signal levels and their associated data transfer rates:

TABLE 4
Conventional Synchronous Transport Signal Transfer Levels

| Signal Level | Optical Carrier | Data Rate |
|---|---|---|
| 1 | STM-1 | 155.520-Mbps |
| 4 | STM-4 | 622.080-Mbps |
| 16 | STS-16 | 2,488.320-Mbps |
| 64 | STS-64 | 9,953.280-Mbps |

Bit Rate is the rate at which individual bits of digitized information is signaled through a communications network. A DS-0 signal of the Digital Signal Hierarchy is signaled through a communications network at 64-kbps.

Bit Rate Hierarchy is a hierarchy of bit rate levels that may be created to accommodate the transmissions of information through a communications network. The Digital Signal Hierarchy has a bit rate hierarchy of 64-kbps, 1.544-Mbps, 3.152-Mbps, 6.312-Mbps and 44.736-Mbps corresponding to the hierarchy levels of DS-0, DS-1, DS-1c, DS2, and DS-3.

The Ethernet communications protocol has physical and logical components. The physical component corresponds to the rate at which information is signaled between sources and sinks of a communications network. The logical component provides a protocol to decipher the digitized data into meaningful bundles of information. Though technology continues to improve and bit rates will continue to rise, the bit rate hierarchy for Ethernet is illustrated as follows in Table 5:

TABLE 5
Ethernet-related Bit Rates

| Bit Rate | Description |
|---|---|
| 1-Mbps | 1/10^{th} Standard Ethernet |
| 10-Mbps | Standard Ethernet |
| 100-Mbps | Fast Ethernet |
| 1,000-Mbps | Gigabit Ethernet |
| 10,000-Mbps | 10-Gigabit Ethernet |

In order to find an optimized network configuration, an engineer must find optimum allocation for the network demands, optimum selection of equipment, optimum routing of the demands and optimum placement of the equipment. Such calculations are extremely time consuming and make significant demands on computer time and memory because of the various protocol hierarchies. Because of the different protocol hierarchies, a method must be developed or a program must be written to perform optimization calculations must be written for each specific configuration of one or more protocol hierarchies. What is needed beyond the prior art is a software program that allows an engineer to enter constraints and preferences and the program determines what nodes, what topologies and what equipment will be used to route the specified demands based upon those constraints and preferences. Moreover, what is needed beyond the prior art is a program that can determine any number of optimized solutions simply by changing the constraints and preferences. In particular, an automated design system is needed that has “constraint based” functionality to quickly generate multiple network scenarios rather than generic network design solutions. Such a system would allow a network engineer to quickly optimize a network configuration with minimal input and minimal data collection.

Therefore, a need exists for a method for a network designer to optimize a network with minimal measurements and data collection in a compressed time period. Further, a need exists for a computer-implemented solution responsive to receipt of user input.

### SUMMARY OF THE INVENTION

Based upon given demands, nodes, spans, speed hierarchy, equipment, weights, preferences and constraints, the apparatus and method disclosed creates an optimized network configuration by separating low degree of separation demands and employing functional analysis for equipment selection and functional analysis for demand routing. The method includes picking a cycle to place equipment on and routing demands on the cycle.

### BRIEF DESCRIPTION OF THE DRAWINGS

The figures presented herein when taken in conjunction with the disclosure form a complete description of the invention, wherein elements and steps indicated by like reference indicators are the same or equivalent elements or steps.

FIG. 1 depicts an example of a point-to-point topology network;

FIG. 2 depicts an example of a star topology network;

FIG. 3 depicts an example of a ring topology network;

FIG. 4 gives an example network arrangement that more closely resembles the topologies found in existing communications networks;

FIG. 5 shows a distributed data processing system in which the present invention can be implemented;

FIG. 6 depicts a data processing system in which the present invention may be implemented;

FIG. 7 depicts a flow chart of the weighted span classification optimization;

FIG. 8 depicts a flow chart of the low degree of separation process;

FIG. 9 depicts a flow chart of the demand routing process;

FIG. 10 depicts a flow chart of the equipment selection process;

FIG. 11 depicts a flow chart of the high degree of separation process; and

FIG. 12 depicts a flow chart of the re-routing process.

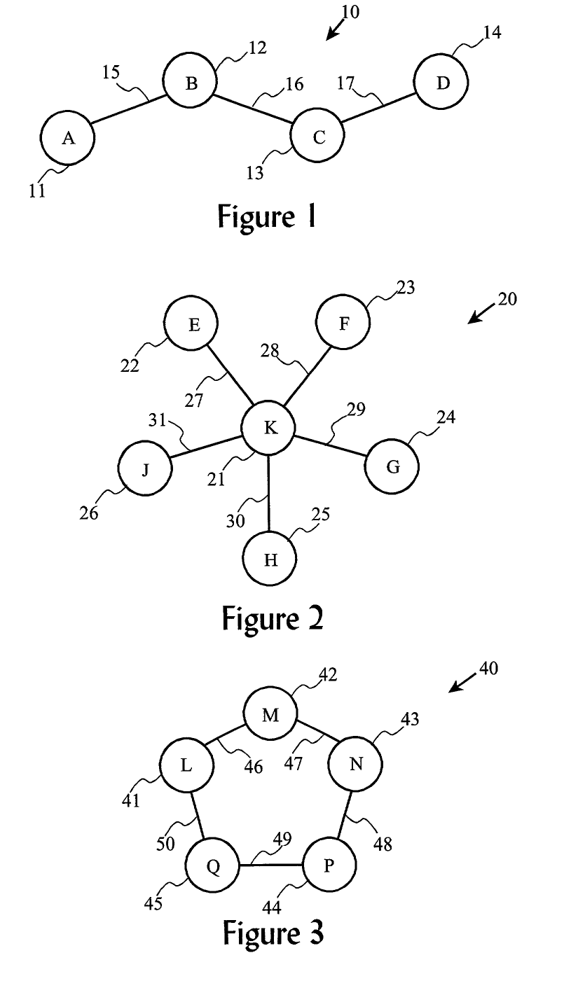

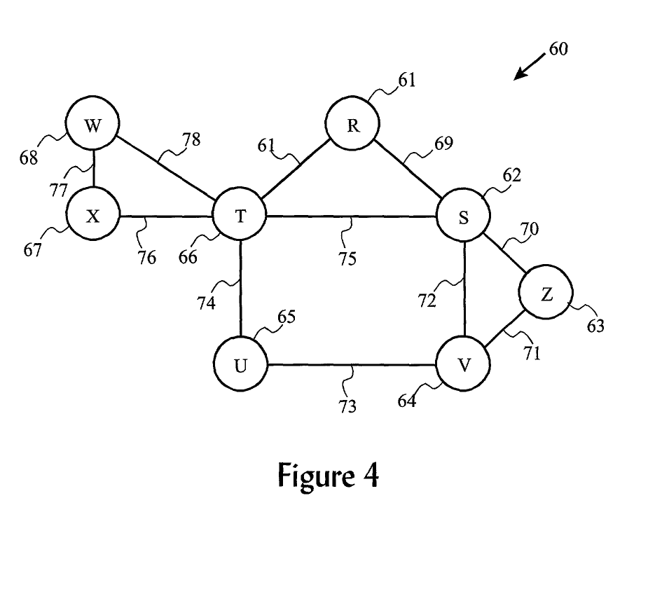

### DETAILED DESCRIPTION OF THE INVENTION

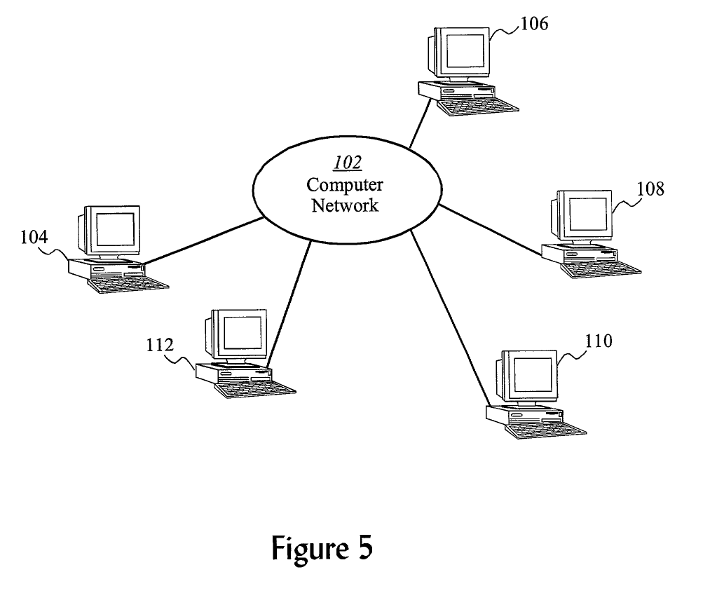

FIG. 5 depicts a pictorial representation of a distributed data processing system in which the present invention may be implemented, and is intended as an example but not as an architectural limitation, for the processes of the present invention. Distributed data processing system 100 is a network of computers which contains a network 102, which is the medium used to provide communications links between various devices and computers connected together within distributed data processing system 100. Network 102 may include permanent connections, such as wire or fiber optic cables, or temporary connections made through telephone connections, personal computers or network computers. Distributed data processing system 100 may include additional servers, clients, and other devices not shown. In the depicted example, distributed data processing system 100 is the Internet with network 102 representing a worldwide collection of networks and gateways that use the TCP/IP suite of protocols to communicate with one another. Distributed data processing system 100 may also be implemented as a number of different types of networks, such as for example, an intranet, a local area network (LAN), or a wide area network (WAN).

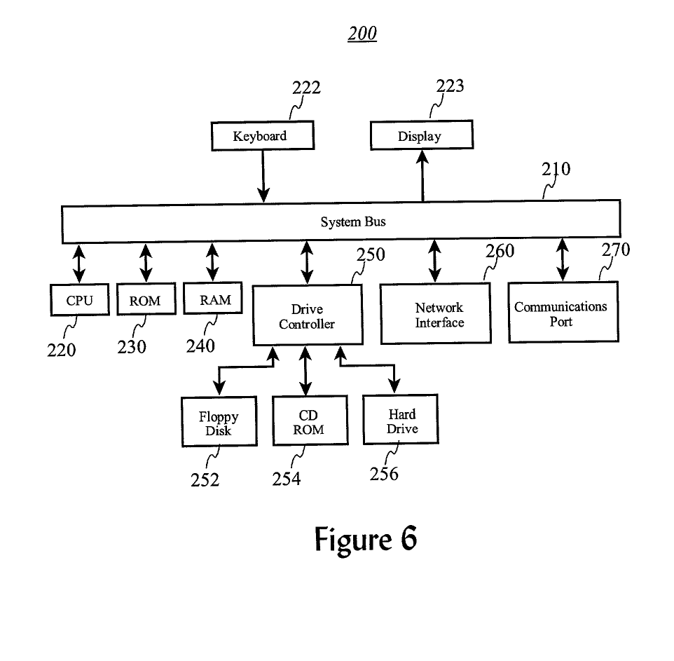

FIG. 6 depicts computer 200. Although the depicted embodiment involves a personal computer, a preferred embodiment of the present invention may be implemented in other types of data processing systems. An exemplary hardware arrangement for computer 200 follows. Keyboard 222 and display 223 are connected to system bus 210. Read only memory (ROM) 230 contains, typically, bootstrap routines and a Basic Input/Output System (BIOS) utilized to initialize Central Processing Unit (CPU) 220 at start up. Random Access Memory (RAM) 240 represents the main memory utilized for processing data. Drive controller 250 interfaces one or more disk type drives such as floppy disk drive 252, CD ROM 254 and hard disk drive 256. The number and type of drives utilized with a particular system will vary depending upon user requirements. A network interface 260 permits communications to be sent and received from a network. Communications port 270 may be utilized for a dial up connection to one or more networks while network interface 260 is a dedicated interface to a particular network. Programs for controlling the apparatus shown in FIG. 6 are typically stored on a disk drive and then loaded into RAM for execution during the start-up of the computer.

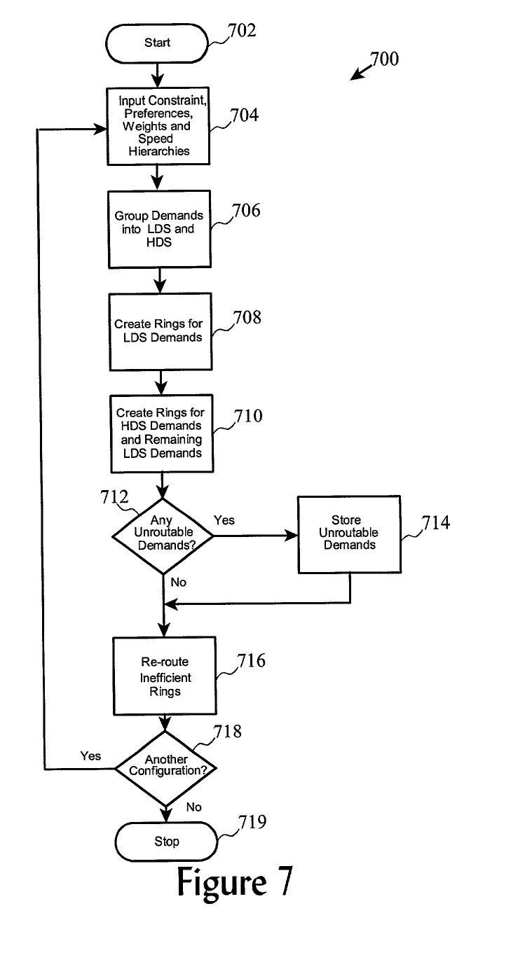

FIG. 7 depicts Weighted Span Process (WS) 700. WS 700 begins (702) and constraints, preferences, weights and speed hierarchies are input (704). The constraints and preferences consist of spans, nodes, equipment, demands, maximum cycle size, minimize hops, minimize distance, preferred cycle size, maximize system utilization and maximize demand quantity placement. Demands are the requested bandwidth to carry traffic between a source node and a destination node and also to carry the traffic in the opposite direction from the destination node back to the source node. The preferred cycle size is the number of nodes that the user would like a cycle to traverse. Maximize system utilization states that the user would like to have rings filled in terms of used capacity being maximized whereas, maximize demand quantity placement states that the user would like to have the maximum number of individual demands routed on a ring. Weights are input. As used herein, weights are numbers selected from a possible range of values reflecting the importance of the parameter to which the weight will be assigned. Weights include the cycle size weight and the demand loading weight. Demand Loading is the numerical weight assigned to how important it is to fill cycles to capacity. Cycle size weight is the numerical weight assigned to how important it is to meet the users preferred cycle size.

Speed hierarchies are input as a list of tuples, of the communications rates permissible in a network. The list must contain at least one tuple known as the Fundamental Unit but may have as many tuples as needed to enumerate all permissible communications rates in a communications network.

A Multiple Unit is a permissible communications rate in a communications network. A Multiple Unit is described as a tuple having both an alphanumeric label and a multiple value. The multiple value may be any positive value greater than or equal to one, and normally an integer value. The multiple value is normally used to indicate how the label of the Multiple Unit tuple relates to the label of the Fundamental Unit for the network under consideration, according to the preferred embodiment.

The Fundamental Unit is the lowest permissible communications rate possible in a communications network. The Fundamental Unit is described as a tuple having an alphanumeric label and a multiple value of one. In a speed hierarchy, the Fundamental Unit indicates that no slower communications rate is permissible in the network under consideration.

The general relationship between the Fundamental Unit and the Multiple Units is illustrated in Table 6.

TABLE 6
Relationship between Fundamental Unit and Multiple Units

| Unit | Label | Multiple |
|---|---|---|
| Fundamental Unit | DS3 | 1 |
| Multiple Unit | OC3 | 3 |
| Multiple Unit | OC12 | 12 |

Data may be input from a location or from multiple locations. Persons skilled in the art will recognize that input can be provided from other computers in a continuous process, may be provided on a schedule, may be provided by magnetic media or may be input by the designer.

Demands are divided into two categories (706). The first category is demands with a Low Degree of Separation (LDS). The second category is demands with a High Degree of Separation (HDS). LDS is an indication that the separation between source and destination nodes is low relative to the set of candidate cycles. The goal is to find a set of demands whose path will be contained within a single ring. HDS is an indication that the separation between source and destination nodes is high relative to the set of candidate cycles. Normally, the term is used to indicate that the path proposed for a single demand will require traversing multiple rings. As used herein, LDS and HDS are defined based upon the maximum cycle size as shown below.

If the number of nodes traversed by a demand's shortest path or the distance traversed by a demand's shortest path is greater than half the maximum cycle size in node count or distance, then the demand is classified as having a HDS. If the number of nodes traversed by a demand's shortest path or the distance traversed by a demand's shortest path is less than or equal to half the maximum cycle size in terms of node count or distance, then the demand is classified as having a LDS.

Next, rings are created for LDS demands that can be placed on a single ring (708). There may be a set of LDS demands that cannot be routed on a single ring due to the fact that their source and destination are not both found on any single candidate cycle. These demands along with the HDS demands will proceed in the WS process 700 which will attempt to route them by adding rings for HDS demands and un-routed LDS demands (710). A determination is made whether there are any un-routable demands (712). Any demands that are not routed by the HDS demand routing will be considered un-routable due to lack of equipment which is compatible with the demand or the destination of the demand being unreachable from the source. These un-routable demands will be stored (714). Any rings in the configuration that exceed the Cost Threshold (CT), defined as the cost of a ring divided by the number of Fundamental Units on the ring, will be labeled as low utilization rings and will be evaluated to determine if there is a cost equivalent or more cost effective way to re-route all of the demands on the ring (716). After all the demands on the low utilization rings have been re-routed, if possible, WS 700 will go to step 718. A determination is made whether there is another configuration sought (718). If there is another configuration sought, WS 700 will go to step 704. If there is not another configuration sought, WS 700 will end (719).

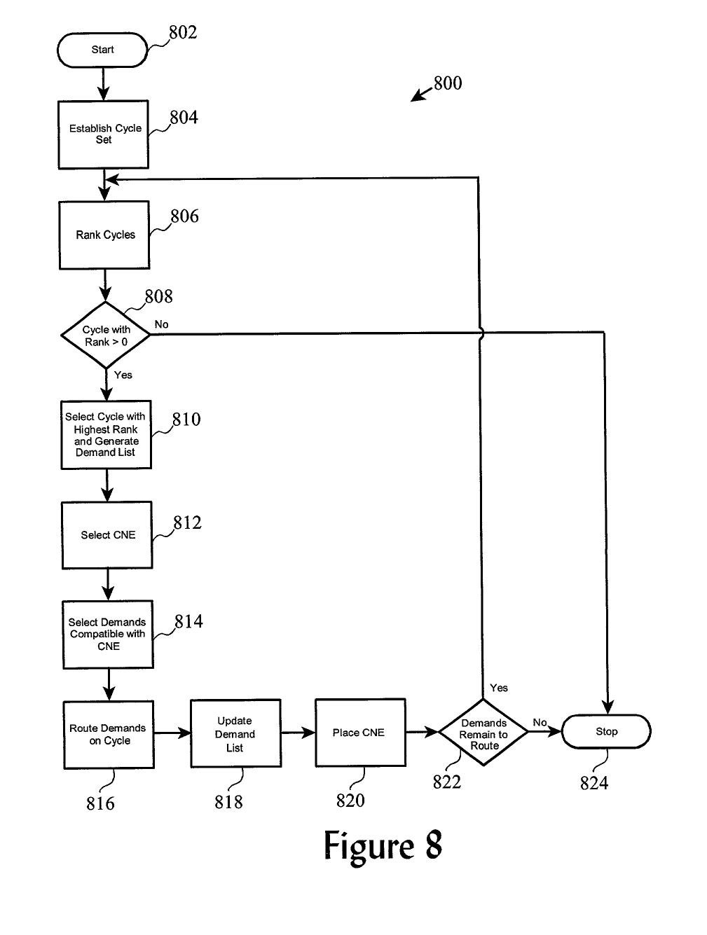

FIG. 8 depicts a flow chart of the process for creating rings for LDS demands, which shall be referred to as the LDS process. LDS 800 begins (802). A cycle set is established (804), using a method such as that set forth in related patent application “Apparatus and Method for Network Cycle Finding,” application Ser. No. 09/710,377.

Each cycle in the cycle set is assigned a rank using a weighted sum (806). The weighted sum for each cycle is calculated using the preferred cycle size (PCS), the cycle size weight (CSW), the cycle size (CS), the demand loading weight (DL), and the total amount of capacity (TC) of the demands whose source and destination are both on this cycle as follows:

Cycle Rank=(CSW*abs((PCS−CS)))+(DL*TC)

Where abs(x) is the mathematical function used to determine the absolute value of the variable x.

Cycle Size Weight is the numerical weight selected by the user to reflect the degree of importance of the preferred cycle size.

Demand Loading is the numerical weight selected by the user to reflect the degree of importance of placing a large capacity of demand on the cycle.

Total Capacity is the total capacity of demands expressed in terms of multiples of the Functional Unit that could possibly be placed on the cycle.

After the cycles are ranked, a determination is made as to whether there are any cycles with a rank greater than zero (808). If no cycles exist with a rank greater than zero, then LDS 800 ends (824). If cycles exist with a rank greater than zero, LDS 800 goes to step (810).

Next, the cycle with the highest rank is selected and a list of demands that have both their source and destination on the cycle is generated (810). A Communication Network Element (CNE) is then selected (812). A CNE is a piece of communications equipment that allows a demand unit to either enter or exit a communications network, or transition to another topology within the communications network.

The list of demands is reduced by eliminating the demands that are not compatible with the selected CNE (814). Demands from this reduced list are routed on the selected cycle (816) and the demand list is updated to reflect which demands were successfully routed (818). The CNE that was selected is placed in the network where needed on the selected cycle (820). A determination is made as to whether there are any demands remaining that can be routed on a single cycle (822). If demands remain, LDS 800 goes to step 806. If no demands remain that can be routed on a single cycle, LDS 800 ends (824).

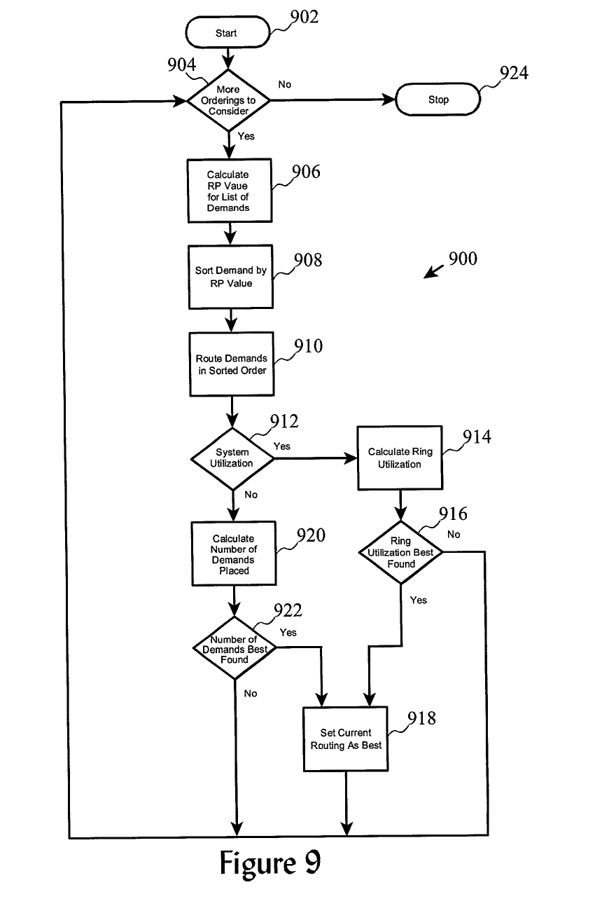

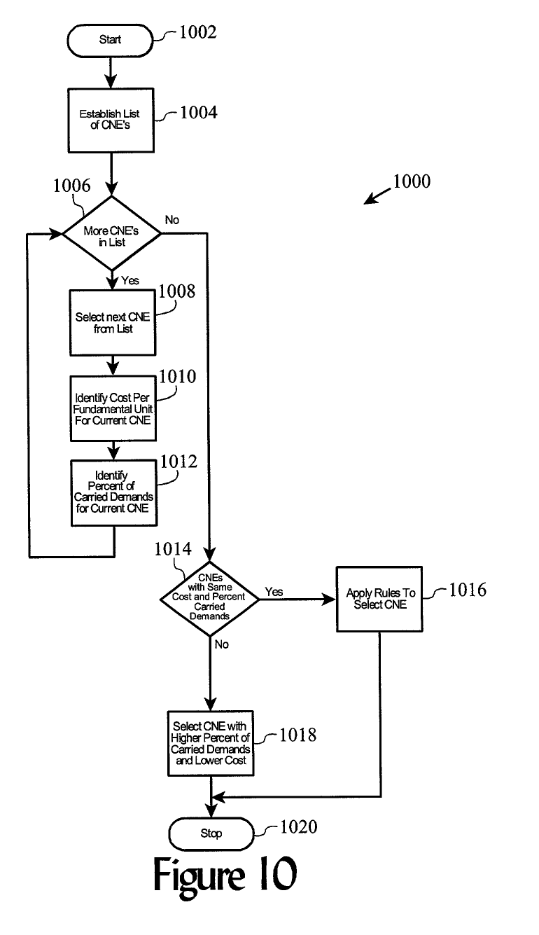

In FIG. 9 Demand Routing process (DR) 900 begins (902). The order in which demands are routed greatly affects the overall network configuration. Therefore, in the preferred embodiment, eight different orderings of demands are considered in the routing process (904). For each of the eight different orderings each of the demands is assigned a “routing priority” (RP) value (906). The RP value is a mathematical representation of how well a demand will fit on a cycle in comparison to other demands depending on the goal of the current ordering. The eight different RP values for a demand are calculated using the following formulas:

| RP Type | Associated RP Formula |
|---|---|
| Heavy | RP = speed |
| Light | RP = 1/speed |
| Long | RP = length |
| Short | RP = 1/length |
| Heavy & Long | RP = x * speed + y * length |
| Heavy & Short | RP = x * speed + y/length |
| Light & Long | RP = x/speed + y * length |
| Light & Short | RP = x/speed + y/length |

The variables x and y can be any value where x+y=1 and 0≦x, y≧1. In the preferred embodiment x is set to 0.4 and y is set to 0.6.

“Heavy” refers to a condition where there are large amounts of bandwidth are consumed by a single demand. “Light” refers to a condition where there are low amounts of bandwidth consumed by a single demand. “Long” refers to a condition where there are a large number of spans traversed by a demand. “Short” refers to a condition where there are a low number of spans traversed by a demand. Speed is the bandwidth that will be consumed by a demand expressed in multiples of the Fundamental Units. Length is the number of nodes that the demands shortest path traverses.

The list of demands is then sorted by the RP value (908). Demands are routed in the sorted order (910). A determination is made as to whether the ordering is going to be evaluated in terms of maximizing system utilization (912). If the ring is to be evaluated in terms of maximizing system utilization then the ring utilization is calculated (914). Ring utilization is determined using a Ring Fill Metric (RFM) that is calculated by the following formula if the number of unused spans is greater than zero:

RFM=((Number of demands on the Cycle)*(Total Flow))/(Number of Unused Spans)

otherwise, by the following formula:

RFM=(Number of demand on the Cycle)*(Total Flow).

The Total Flow is equal to the sum the bandwidth consumed by the demands on the cycle expressed in multiples of the Fundamental Unit. A determination is made as to whether the current ring utilization is the best found (highest RFM value) so far (916). If the ring utilization is found not to be the best utilization, then the process returns to step 904 and a determination is made whether there are more orderings to consider. Otherwise, if the ring utilization is found to be the best utilization found so far, then the current routing is set to best (918). The process then returns to step (904), and a determination is made as to whether there are more orderings to consider.

If Demand Quantity Placement is to be used (912), then the number of demands placed on the ring is calculated (920). Demand Quantity Placement is the DR's 900 attempt to place the maximum possible number of demands on a cycle. If the ordering of demands in terms of maximizing Demand Quantity Placement is found to be best so far (922), then the current routing is set as the best routing (918). The process returns to step 904, and a determination is made as to whether there are more orderings to consider. If the ordering of demands in terms of maximized Demand Quantity Placement is found not to be best (922), then the process returns to the step of determining whether there are more orderings to consider (904). If there are no more orderings to consider, then the process ends (924).

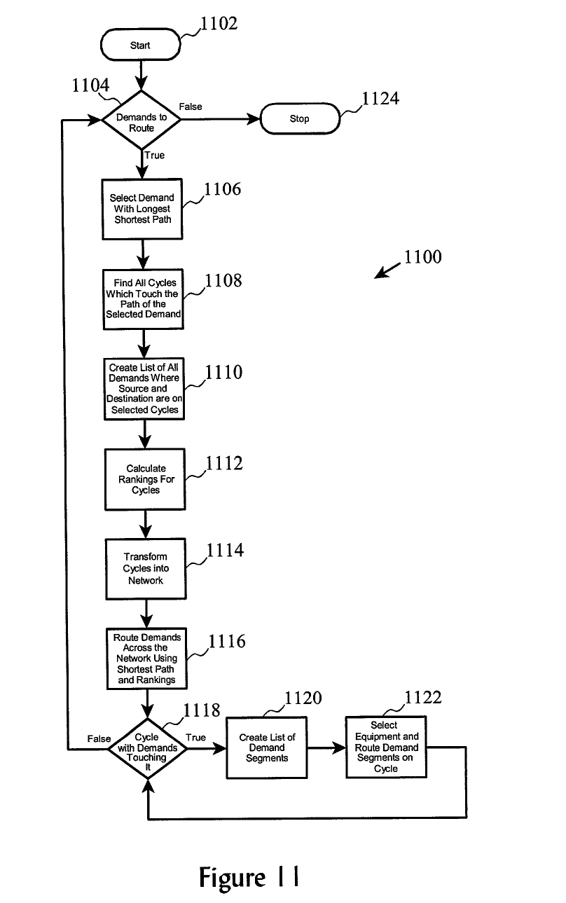

In FIG. 10, Equipment Placing process (EP) 1000 begins (1002). A list of CNE's is established (1004). A determination is made as to whether there are more CNE's, which have not been evaluated (1006). If there are more CNE's to evaluate, the next CNE is selected from the list of CNE's to be evaluated (1008). The selected CNE defines a technology and a speed for a proposed ring. For the selected CNE, a list of demands that are compatible with that CNE is created.

Next, the maximum number of rings that are needed to route all of the demands is calculated. This number is equal to the maximum number of CNE's needed at any one node. Using the maximize number of rings along with the estimated cost of CNE's at each node an estimated cost per Fundamental Unit is calculated (1010).

The percent of carried demands is calculated by dividing the maximum number of demands that could be routed on the cycle using the selected CNE by the total number of demands that could be routed on the cycle (1012).

Once all of the CNE's have been considered (1006), a determination is made whether there are several CNE's that have an estimated cost per Fundamental Unit, which is approximately the same, and which have approximately the same percent of carried demands (1014). If there are, two rules are applied to select a CNE (1016). First, choose bi-directional line switch ring (BLSR) over unidirectional path switch ring (UPSR). Second, the CNE with the highest capacity is chosen. For example, select BLSR4 OC48 over BLSR4 OC12 and BLSR4 OC12 over UPSR OC12.

If there are no CNE's with the same cost and same percent of carried demands (1014), the CNE with the highest percent of carried demands and the lowest cost (1018) is selected, and EP 1000 ends (1020).

Referring to FIG. 11, the HDS process 1100 begins (1102). A determination is made whether there are demands to route (1104). If so, the demand with the highest degree of separation is selected (1106). All cycles are found that touch the path of the selected demand (1108). In other words, all cycles that have a span or node in common with the demand path are found.

A list is created of all demands whose source and destination are on the selected cycles (1110). Rankings for each of the cycles is calculated based on the number of source and destinations of demands that are located on the cycle, the number of spans the original demand touches, and how close the cycle comes to the preferred cycle size (1112).

Cycles are transformed into a network where the cycles become nodes and the connections between cycles become spans (1114). Demands are routed across the network using a shortest path algorithm where the rankings are weights on the spans (1116).

A determination is made whether there is a cycle with demands touching it (1118). If there is not a cycle with demands touching it, the process returns to step 1104. If there is a cycle with demands touching it, a list of demand segments is created (1120). Demand segments are portions of demand paths that are on the cycle currently being routed.

Equipment is selected and demand segments are routed on the cycle (1122) using the process described in FIG. 10. Demands are routed using the process described in FIG. 9. Another determination is made whether there is another cycle with demands touching it (1118), and processing proceeds as previously described.

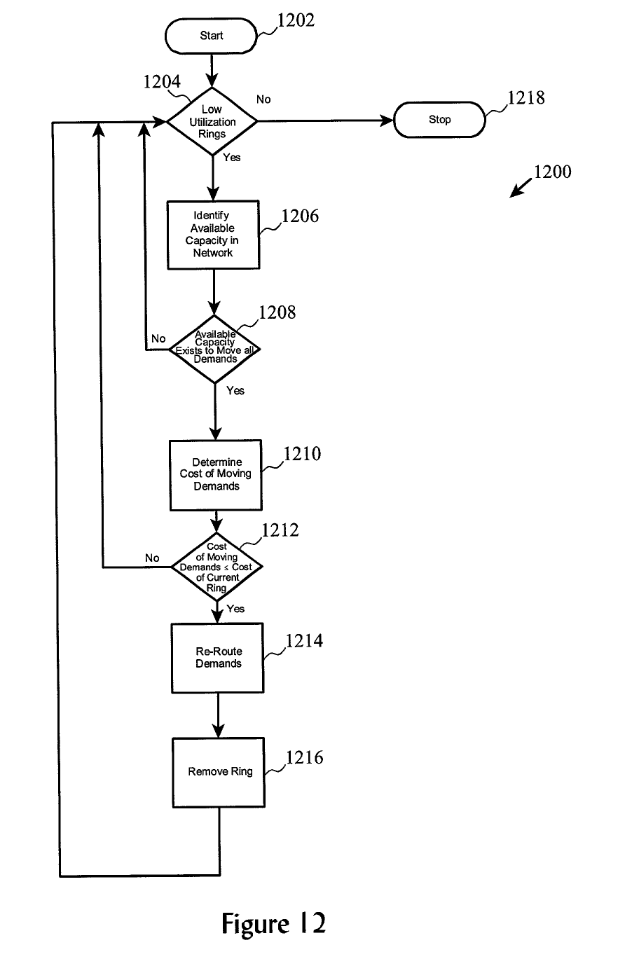

FIG. 12 depicts the logical process of the Re-routing process (RR) 1200. RR 1200 begins (1202). A determination is made if there are any rings in the configuration that exceed the Cost Threshold. If there are rings in the configuration that exceed the Cost Threshold, these rings will be labeled as low utilization rings (1204). If there are low utilization rings present in the configuration, the ring that exceeds the cost threshold by the largest amount is selected and then available capacity in the network is identified (1206).

Next, a determination is made as to whether there is sufficient capacity available to move all demands off the current low utilization ring (1208). If there is not enough capacity available, processing returns to step 1204. If enough capacity exists (1208), then the cost of moving the demands onto other rings from the low utilization ring is determined (1210).

A determination is made whether it is more cost effective to move the demands onto other rings or to leave them on the low utilization ring (1212). If it is not cost efficient to move them, then processing returns to step 1204 to consider the next low utilization ring.

If it is cost effective to move the demands, then the demands are re-routed (1214). Demands can be re-routed by moving them all to another single ring, or by splitting them up between multiple rings. Now, the low utilized ring is removed (1216), and processing returns to step 1204. When all of the low utilization rings have been examined, the process ends (1218).

While certain details of the preferred embodiment have been disclosed herein, it will be recognized by those skilled in the art that many variations, substitutions, and alternate embodiments may be employed without departing from the spirit and scope of the invention, including use of alternate programming methodologies, equivalent process step orders, and equivalent data representations. Therefore, the scope of the invention disclosed herein should be determined by the following claims.

1. A method for creating a network configuration for low degree of separation demands comprising:
specifying demands, nodes, spans, speed hierarchy, equipment, weights, preferences and constraints;
selecting a Fundamental Unit;
identifying a plurality of low degree of separation demands;
performing calculations based upon the constraints, speed hierarchies, preferences and fundamental unit to select a cycle, place equipment and route demands

2. The method of claim 1 further comprising defining degree of separation.

3. The method of claim 1 further comprising routing low degree of separation demands.

4. The method of claim 1 further comprising the step of equipment selection.

5. The method of claim 1 further comprising the step demand routing.

6. The method of claim 1 further comprising the step of placing equipment.

7. The method of claim 1 further comprising enumerating a cycle set.

8. The method of claim 1 further comprising ranking a cycle set by weights.

9. The method of claim 1 further comprising, for each cycle, creating a list of demands that could possibly be placed on the cycle.

10. The method of claim 1 further comprising selecting a cycle with a highest rank.

11. The method of claim 1 further comprising selecting a CNE.

12. The method of claim 1 further comprising selecting demands that are compatible with a selected CNE.

13. The method of claim 1 further comprising routing demands on a cycle.

14. The method of claim 1 further comprising updating a demand list to delete a routed demand.

15. The method of claim 1 further comprising placing a CNE.

16. The method of claim 1 further comprising updating a cycles rank.

17. The method of claim 1 further comprising calculating a weighted sum using the formula (CSW*abs((PCS−CS)))+(DL*TC) where abs(x) is a mathematical function used to determine an absolute value of a variable x.

18. A method for creating a network configuration for low degree of separation demands comprising:
specifying demands, nodes, spans, speed hierarchy, equipment, weights, preferences and constraints;
selecting a Fundamental Unit;
identifying low degree of separation demands;
performing calculations based upon the constraints, speed hierarchies, preferences and Fundamental Unit to select a CNE.

19. The method of claim 18 further comprising, responsive to a determination that there are a plurality of CNEs with a same cost and a same percent of carried demands, choosing BLSRx over UPSR and choosing a CNE with the highest capacity.

20. A method for creating a network configuration for low degree of separation demands comprising:
specifying demands, nodes, spans, speed hierarchy, equipment, weights, preferences and constraints;
selecting a Fundamental Unit;
identifying a plurality of low degree of separation demands;
performing calculations based upon the constraints, speed hierarchies, preferences and fundamental unit to route demands.

21. The method of claim 20 further comprising inputing unrouted demands and a cycle wherein each demand has a speed and a computed shortest path.

22. The method of claim 20 further comprising creating a definition of an RP.

23. The method of claim 20 further comprising calculating an RP for each demand.

24. The method of claim 20 further comprising sorting demands by RP.

25. The method of claim 20 further comprising routing demands in order of an RP value.

26. The method of claim 20 further comprising the step of determining ring utilization by calculating a ring fill metric (RFM) using the formula RFM=((Number of Demands on the Cycle)*(total Flow)/(Number of Unused Spans) if the Number of Unused Spans is greater than 0, and using the formula RFM=(Number of Demands on the Cycle)*(Total Flow) if the number of unused spans is 0.

27. The method of claim 20 further comprising calculating an RP for each demand using the formula RP=speed.

28. The method of claim 20 further comprising calculating an RP for each demand using the formula RP=1/speed.

29. The method of claim 20 further comprising calculating an RP for each demand using the formula RP=length.

30. The method of claim 20 further comprising calculating an RP for each demand using the formula RP=1/length.

31. The method of claim 20 further comprising calculating an RP for each demand using the formula RP=x*speed+y*length where x+y=1 and 0≦x, y≧1.

32. The method of claim 20 further comprising calculating an RP for each demand using the formula RP=x*speed+y/length where x+y=1 and 0≦x, y≧1.

33. The method of claim 20 further comprising calculating an RP for each demand using the formula RP=x/speed+y*length where x+y=1 and 0≦x, y≧1.

34. The method of claim 20 further comprising calculating a goodness for each demand using the formula RP=x/speed+y/length where x+y=1 and 0≦x, y≧1.

35. A programmable apparatus for creating a network configuration comprising:
a computer having a memory; and
a software program installed in said memory;
wherein the computer is directed by said software program to receive input comprising;
constraints, preferences, a speed hierarchy, and selection of a Fundamental Unit;
and responsive to receiving said input, the computer is directed to:
identify demands that are low degree of separation demands.

36. The programmable apparatus of claim 35 wherein the speed hierarchy comprises:
a list of tuples;
wherein one of said tuples is the Fundamental Unit.

37. The programmable apparatus of claim 35 wherein the speed hierarchy contains a Multiple Unit; and wherein said Multiple Unit is a permissible communications rate in a communications network;
wherein said Multiple Unit is described as a tuple having both an alphanumeric label and a multiple value; and
wherein the multiple value may be any positive value greater than one.

38. The programmable apparatus of claim 35 wherein said list comprises a Multiple Unit with a multiple value of the Fundamental Unit.

39. The programmable apparatus of claim 35 wherein the Fundamental Unit is the lowest permissible communications rate permissible in the communications network, and wherein the Fundamental Unit is described as a tuple having an alphanumeric label and a multiple value of one.

40. The programmable apparatus of claim 35 wherein the speed hierarchy is a T-Carrier.

41. The programmable apparatus of claim 35 wherein the speed hierarchy is an E-Carrier.

42. The programmable apparatus of claim 35 wherein the speed hierarchy is an SDH.

43. The programmable apparatus of claim 35 wherein the speed hierarchy is a SONET.

44. The programmable apparatus of claim 35 wherein the speed hierarchy is an Ethernet.

45. The programmable apparatus of claim 35 wherein the speed hierarchy is a DS-n.

46. The programmable apparatus of claim 36 wherein the speed hierarchy is an E-n.

47. The programmable apparatus of claim 37 wherein the speed hierarchy is an Optical Carrier (OC-n).

48. The programmable apparatus of claim 35 wherein the speed hierarchy is a Synchronous Transport Module (STM-n).

49. The programmable apparatus of claim 35 wherein the speed hierarchy is a Synchronous Transport Signal (STS-n).
